(19) United States
(12) Patent Application Publication
(10) Pub. No.: US 2006/0137008 A1
(43) Pub. Date: Jun. 22, 2006

(54) Techniques for providing secure communication modes

(75) Inventor: Moshe Maor, Kiryat Mozkin (IL)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/015,873

(22) Filed: Dec. 16, 2004

(51) Int. Cl. G06F 12/14

(52) U.S. Cl. 726/22

(57) ABSTRACT

Techniques to limit the control of component hardware devices in a computer system by external devices or external software programs.

### FIELD

The subject matter disclosed herein relates to techniques to maintain security in computer systems.

### RELATED ART

In the computing environment, malicious software such as viruses and worms are prevalent. Malicious software typically seek to disrupt or take control of the operation of a computer. It is desirable to prevent malicious software from manipulating operation of the computer.

### BRIEF DESCRIPTION OF THE DRAWINGS

FIG. 1 depicts a system in which some embodiments of the present invention may be used.

FIG. 2 depicts an example computer system that can use embodiments of the present invention.

FIG. 3A depicts an example implementation of a HW component, in accordance with embodiments of the present invention.

FIG. 3B depicts an example implementation of a network interface, in accordance with embodiments of the present invention.

FIG. 4 provides a state diagram of some possible states of embodiments of HW components, in accordance with embodiments of the present invention.

FIG. 5 depicts an example process that can be used in embodiments of the present invention to control the extent to which a hardware component is controllable by an external device or routine.

FIG. 6 depicts an example timing diagram showing movement between trusted and untrusted states, in accordance with embodiments of the present invention.

Note that use of the same reference numbers in different figures indicates the same or like elements.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

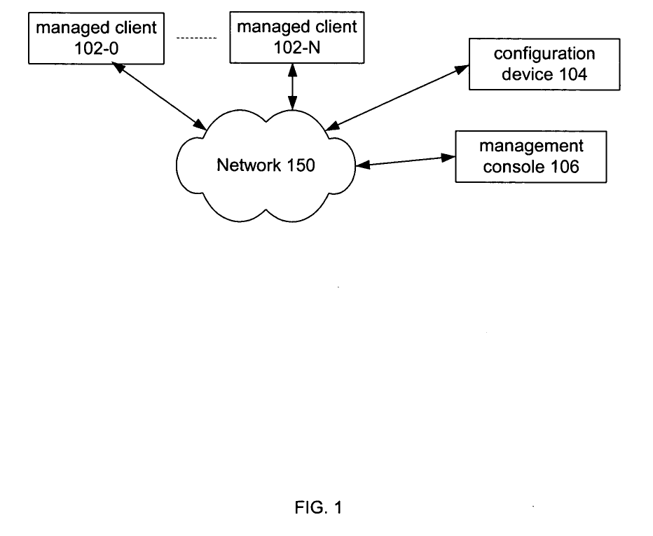

For example, FIG. 1 depicts a system in which some embodiments of the present invention may be used. The system may include managed client devices 102-0 to 102-N, configuration device 104, and management console 106. Managed client devices 102-0 to 102-N, configuration device 104, and management console 106 may communicate using network 150.

Network 150 may be any network such as the Internet, an intranet, a local area network (LAN), storage area network (SAN), a wide area network (WAN), or wireless network. Network 150 may exchange traffic with computer system using the Ethernet standard (described in IEEE 802.3 and related standards) or any communications standard.

For example, any of managed client devices 102-0 to 102-N may be implemented as any computer such as a personal computer or server computer. In one embodiment, any of managed client devices 102-0 to 102-N may provide to management console 106 information such an asset description of itself as well as, but not limited to, information related to suspected hardware failures and key strokes entered by a user in response to a login request. In one embodiment, any of managed client devices 102-0 to 102-N may isolate itself from network 150 so as to prevent access by and to network 150.

Configuration device 104 may provide a directory of managed client devices and a protocol for communication between management console 106 and any of managed client devices 102-0 to 102-N. For example, to provide communication, configuration device 104 may utilize Dynamic Host Configuration Protocol (DHCP) and/or Domain Name System (DNS) protocol, although other protocols may be used. In one embodiment, management console 106 and configuration device 104 may be combined into a single device.

Management console 106 may provide capability to a user to view assets of any of managed client devices 102-0 to 102-N (e.g., hardware, software, and/or data in each of managed client devices 102-0 to 102-N) as well as other status information of the managed client device (such as boot-up records). Management console 106 may provide capability to a user to monitor any of managed client device 102-0 to 102-N regardless of the state of the operating system or power-mode of any of managed client devices 102-0 to 102-N. In one embodiment, management console 106 may intercommunicate with each of managed client devices 102-0 to 102-N via Extensible Markup Language (XML) scripts, although other protocols may be used.

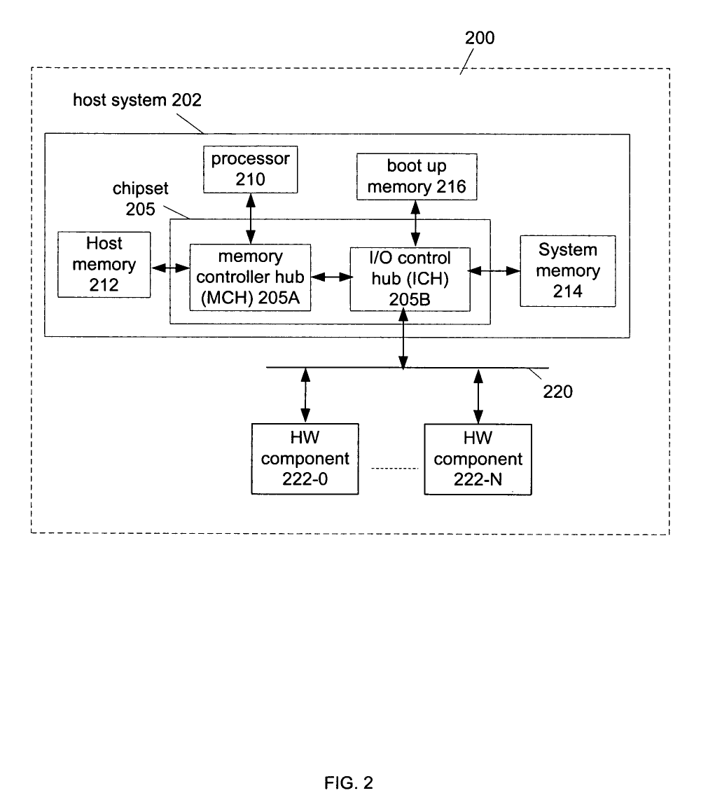

FIG. 2 depicts in computer system 200 a suitable implementation of any of managed client devices 102-0 to 102-N. Computer system 200 may include chipset 205, processor 210, host memory 212, system memory 214, boot-up memory 216, bus 220, and hardware (HW) components 222-0 to 222-N.

Chipset 205 may include a memory controller hub (MCH) 205A that may provide intercommunication among processor 210 and host memory 212 as well as a graphics adapter that can be used for transmission of graphics and information for display on a display device (both not depicted). Chipset 205 may further include an I/O control hub (ICH) 205B that may intercommunicate with MCH 205A and may provide intercommunication among system memory 214, boot up memory 216, and bus 220.

Processor 210 may be implemented as Complex Instruction Set Computer (CISC) or Reduced Instruction Set Computer (RISC) processors, multi-core, or any other microprocessor or central processing unit. Host memory 212 may be implemented as a volatile memory device (e.g., Random Access Memory (RAM), Dynamic Random Access Memory (DRAM), or Static RAM (SRAM)). System memory 214 may be implemented as a non-volatile storage device such as a magnetic disk drive, optical disk drive, tape drive, an internal storage device, an attached storage device, and/or a network accessible storage device. Routines and information stored in system memory 214 may be loaded into host memory 212 and executed by processor 210. For example, system memory 214 may store an operating system as well as applications used by system 200.

Boot-up memory 216 may be implemented as a non-volatile memory such as read only memory (ROM), Erasable Programmable ROM (EPROM), Electrically Erasable Programmable ROM (EEPROM), Masked ROM, or flash memory. Boot-up memory 216 may at least store a basic input/output system (BIOS) and an asset description of a managed client device. In one embodiment, during the boot-up of system 200, BIOS may determine the asset description as well as a boot record. For example, the asset description may include, but not be limited to, make/model of the managed client device, serial number of processor 210, storage size of host memory, storage size of system memory 214, plug-and-play ID list (e.g., list of hardware peripherals either by serial number of by a general name). Some asset description may be hard coded whereas some may be measured during boot-up (e.g., storage size of host memory, storage size of system memory 214, plug-and-play ID list). The boot record of system 200 may include suspected hardware failures or indicators measured during the boot-up process (e.g., host memory 212 check, hard disk check/invalid boot sector).

Bus 220 may provide intercommunication among host system 202 and HW components 222-0 to 222-N. Bus 220 may support node-to-node or node-to-multi-node communications. Bus 220 may be compatible with Peripheral Component Interconnect (PCI) described for example at Peripheral Component Interconnect (PCI) Local Bus Specification, Revision 2.2, Dec. 18, 1998 available from the PCI Special Interest Group, Portland, Oreg., U.S.A. (as well as revisions thereof); PCI Express described in The PCI Express Base Specification of the PCI Special Interest Group, Revision 1.0a (as well as revisions thereof); PCI-x described in the PCI-X Specification Rev. 1.0a, Jul. 24, 2000, available from the aforesaid PCI Special Interest Group, Portland, Oreg., U.S.A. (as well as revisions thereof); serial ATA described for example at “Serial ATA: High Speed Serialized AT Attachment,” Revision 1.0, published on Aug. 29, 2001 by the Serial ATA Working Group (as well as related standards); Universal Serial Bus (USB) (and related standards); as well as other interconnection standards.

HW components 222-0 to 222-N may be any device capable of receiving information or instruction from host system 202 or providing information or instruction to host system 202. Any of HW components 222-0 to 222-N may be capable of providing information or instruction to another of HW components 222-0 to 222-N or receiving information or instruction from another of HW components 222-0 to 222-N. HW components 222-0 to 222-N can be integrated into the same computer platform as that of host system 202.

For example, any of HW components 222-0 to 222-N may be implemented as a display adapter, hard drive (which may be initially configured by BIOS only or by its own BIOS extension), parts of the chipset (ICH/MCH) that can be configured only when the host system powers up and locked thereafter; although other examples are possible.

In one embodiment, at least one of HW components 222-0 to 222-N may be implemented as a network interface capable of providing intercommunication between computer system 200 and a network (such as but not limited to network 150). For example, the network interface may be capable of intercommunicating with chipset 205 through bus 220.

In one embodiment, any of HW components 222-0 to 222-N may be capable of entering multiple phases, whereby in each phase, the extent to which the HW component complies with instructions provided from a source external to the HW component (e.g., whether another HW component or from host system 202) is reduced. For example, in a trusted phase, the HW component may comply with any instructions provided by any source(s) external to the HW component. For example, in an untrusted phase, the HW component may not comply with any instructions provided by any external source(s). Accordingly, to the extent that code which may be malicious attempts to control a HW component in the untrusted phase, access to the HW component may be denied. For example, the HW component may respond to instructions received during the untrusted phase by ignoring the instruction or providing a pre-programmed generic response.

In one embodiment, triggering events may change a state of any of HW components 222-0 to 222-N from a trusted phase to an untrusted phase and vice versa. Triggering events detectable by HW components that cause them to enter the trusted phase include platform events which no software component can trigger and which cause the very next step to be execution of a trusted source. For example, a trusted source may include a BIOS code prior to requesting that code be executed that is off-BIOS. Off-BIOS code may include, but not be limited to, code in a memory other than boot up memory 216; operating system (such as Linux, DOS or Windows); or any third party “ROM extension” code that the BIOS can request be executed. Examples of third party ROM extensions include, but are not limited to: code used by Small Computer Systems Interface (SCSI) adapters to initialize SCSI adapters and Pre-boot Execution Environment (PXE) code enabling an operating system (OS) to be loaded from a network using network interface. Other trusted sources may include software that can not be added except by a trusted source or authorized person and after added, cannot be subsequently changed except by a trusted source or authorized person.

For example, the triggering event causing HW components to enter the trusted phase may include a PCI-reset de-assertion event in host system 202. Under PCI, after a PCI-reset de-assertion event occurs, the processor is being reset and the next step is for the processor to execute BIOS code. For example, power-up or restart of the system may trigger a PCI-reset de-assertion event.

For example, a triggering event causing entrance to the untrusted phase includes a trusted source (such as a BIOS) notifying that an untrusted source will next be executed or an indication to enter an untrusted phase, although other triggering events may be used. For example, a BIOS notification prior to running code that is off-BIOS code may trigger entering the untrusted phase.

In one embodiment, there may be multiple levels of trust. For example, there may be a trusted phase, semi-trusted phase, and untrusted phase. During the semi-trusted phase, the HW component may execute a limited set of instructions or execute instructions issued by a limited set of sources. For example, a source may identify itself by a source identifier in the access request.

Other example triggers that may cause a movement to a trusted or semi-trusted phase include a non-maskable interrupt (NMI) and system management interrupt (SMI). An NMI may trigger a host processor to next execute a BIOS and thereby cause movement to a trusted phase. An NMI may trigger a host processor to next execute less trusted code than the BIOS such as an OS kernel and thereby cause movement to a semi-trusted phase whereby a limited set of instructions from the OS kernel may be transferred to the HW core logic for execution. An SMI may trigger a host processor to next execute a BIOS and so cause movement to a trusted phase. Further examples of OS and BIOS instructions that may be transferred to core logic include storing a user's key stroke during login.

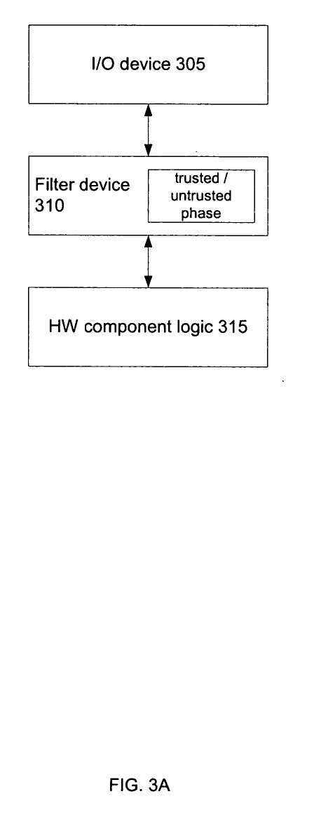

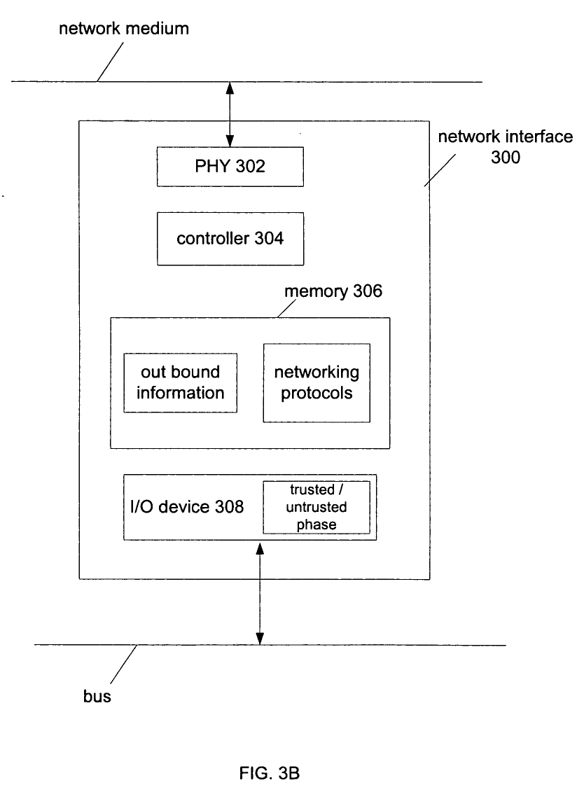

For example, FIG. 3A depicts an example implementation of a HW component that includes the capability to enter trusted or untrusted phases, in accordance with embodiments of the present invention. The HW component may include I/O device 305, filter device 310, and HW component logic 315. I/O device 305 may provide intercommunication between the HW component and an external device such as bus 220. Filter device 310 may respond to commands to enter trusted or untrusted phases in response to triggering events. For example, filter device 310 may be programmed to recognize triggering events which cause entering trusted or untrusted phases. Filter device 310 may transfer instructions to the HW component logic 315 provided to the HW component during the trusted phase but block instructions provided to the HW component during the untrusted phase from reaching the HW component logic 315. When a semi-trusted phase is supported, filter device 310 may transfer to the HW component logic 315 pre-identified instructions or instructions from sources which are trusted. HW component logic 315 may generally provide the core intelligence of the HW component. HW core logic 315 may include microchips or integrated circuits interconnected using conductive leads of a motherboard, hardwired logic, software stored by a memory device and executed by a microprocessor, firmware, an application specific integrated circuit (ASIC), a memory or storage device, and/or a field programmable gate array (FPGA).

In one embodiment, HW components 222-0 to 222-N may be implemented as any or a combination of: hardwired logic, software stored by a memory device and executed by a microprocessor, firmware, an application specific integrated circuit (ASIC), and/or a field programmable gate array (FPGA).

For example, FIG. 3B depicts an example implementation of a network interface 300 in accordance with an embodiment of the present invention. Network interface 300 may include physical layer interface (PHY) 302, controller 304, memory 306, and I/O device 308.

PHY 302 may provide network interface 300 access to a network medium of a network so that transmission and receipt of packets and frames between the network and network interface 300 is supported.

Controller 304 may encode packets or frames to be transmitted to the network in conformance with protocols such as Ethernet, SONET/SDH, and/or OTN. Similarly, controller 304 may decode packets or frames received from the network in conformance with protocols such as Ethernet, SONET/SDH, and/or OTN.

Memory 306 may store information used by controller 304 in the packet and frame encoding and decoding processes. Memory 306 may store contents of packets and frames received from the network as well as contents of packets and frames that can be transferred to the network. For example, memory 306 may store information to be transferred to a device such as host system 202 or information to be transferred from a device such as host system 202 to a device on the network (such as a management console). Memory 306 may store applications and protocols used by network interface 300 to communicate with external devices such as, but not limited to, a management console.

I/O device 308 may provide intercommunication between the bus (which can be used to access host system 202) and the network interface 300. I/O device 308 may further monitor for triggering events to enter a trusted or untrusted phase and filter information provided to network interface 300 based on the trusted/untrusted phase.

In one embodiment, a KCS interface defined in Intelligent Platform Management Interface (IPMI) standard running over PCI may be used to provide intercommunication between a BIOS (executed by the host system) and network interface 300. For example, information determined by a BIOS such as hardware asset information or information related to boot-up records may be transferred from the BIOS to the network interface 300 during a trusted phase using the KCS interface. Information transferred to network interface 300 during the trusted phase may be stored in memory 306. For example, during the trusted phase, the network interface 300 may transfer information to the BIOS such as a password or a key using the KCS interface. Accordingly, information transferred during the trusted phase may be relied upon as uncorrupted.

For example, a device such as management console 106 may request information from host system 202 by providing the request to network interface 300 through a network. In one embodiment, management console 106 may request asset description information or boot-up records using XML compatible communications. Accordingly, information concerning host system 202 may be transferred to a device such as management console 106 regardless of the operating system or power-use state of host system 202 by providing the information to network interface 300 for storage and transfer.

Network interface 300 may be implemented as any or a combination of: microchips or integrated circuits interconnected using conductive leads of a motherboard, hardwired logic, software stored by a memory device and executed by a microprocessor, firmware, an application specific integrated circuit (ASIC), and/or a field programmable gate array (FPGA). For example, network interface 300 may be integrated into a chipset (such as but not limited to chipset 205) in a LAN-on-motherboard implementation; implemented as a network interface card that can be plugged into a bus interface in a motherboard platform that provides intercommunication with the computer system (such as but not limited to chipset 205); and/or in part be implemented using a host processor.

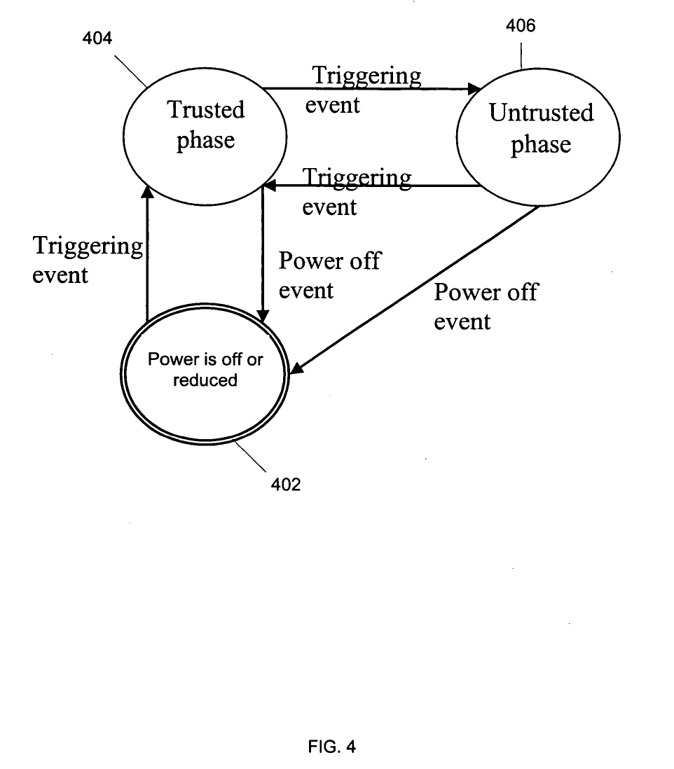

FIG. 4 provides an example state diagram of some possible states of embodiments of HW components, although other states are possible, in accordance with embodiments of the present invention. State 402 may be a power-off or reduced power-use state of the computer system or any state where the next operating step of the computer system is execution of a trusted source (e.g., execution of a BIOS). State 402 may be a low power mode such as hibernate whereby under PCI, after hibernate, a PCI reset de-assertion occurs followed by the BIOS executing.

Triggering events detectable by HW components that cause a change from state 402 to state 404 may include platform events which no software component can trigger and which cause the very next step to be execution of a trusted source. For example, the triggering event causing HW components to enter the trusted phase may include a PCI-reset de-assertion event in host system 202.

State 404 may be a trusted phase whereby the HW component may comply with any instructions provided by external source(s). In one embodiment, power-off or reduction in power events may trigger a change from state 404 to 402. In one embodiment, an indication from a trusted source that the trusted source will cease to execute may trigger a change from state 404 to state 406. For example, a BIOS indicating it is to request execution of a third party “ROM extension” code may trigger a change from state 404 to state 406.

State 406 may be an untrusted phase whereby the HW component may not comply with any instructions provided by any external source(s). In one embodiment, power-off or reduction in power events may trigger a change from state 406 to 402. In one embodiment, triggering events that may cause a change from state 402 to 404 may cause a change from state 406 to 404.

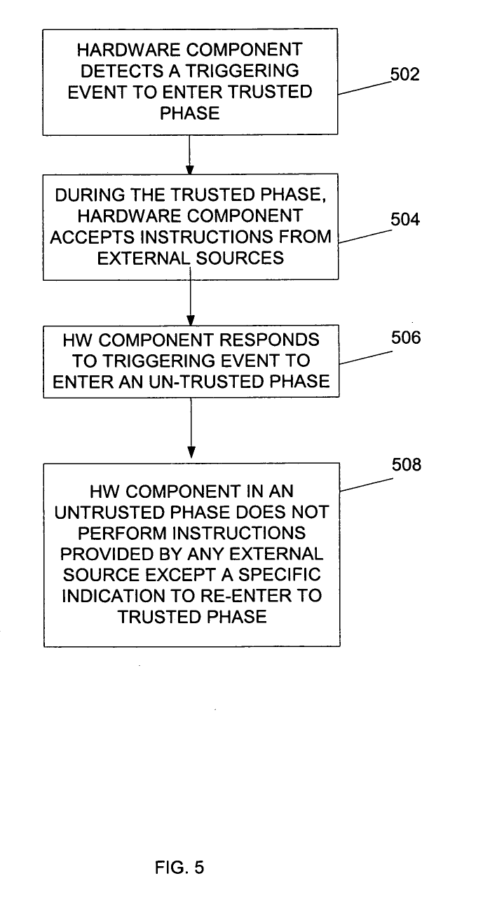

FIG. 5 depicts an example process that can be used in embodiments of the present invention to control the extent to which a hardware component is controllable by an external device or routine.

At 502, a hardware component detects a triggering event to enter trusted phase. For example, the trusted phase can be entered by detection of a PCI reset de-assertion event following a platform power-up or restoration to full-power. Other triggering events detectable by HW components that cause them to enter the trusted phase include platform events which no software component can trigger. Another triggering event can be an event which causes the very next step to be execution of a trusted source.

At 504, during the trusted phase, the HW component accepts instructions from external sources.

At 506, the HW component responds to a triggering event to enter an un-trusted phase. For example, a triggering event causing entrance to the un-trusted phase includes a trusted source (such as a BIOS) notifying that an un-trusted source will next be executed or to enter an untrusted phase.

At 508, HW component in an untrusted phase does not perform instructions provided by any external source except a specific indication to re-enter to trusted phase.

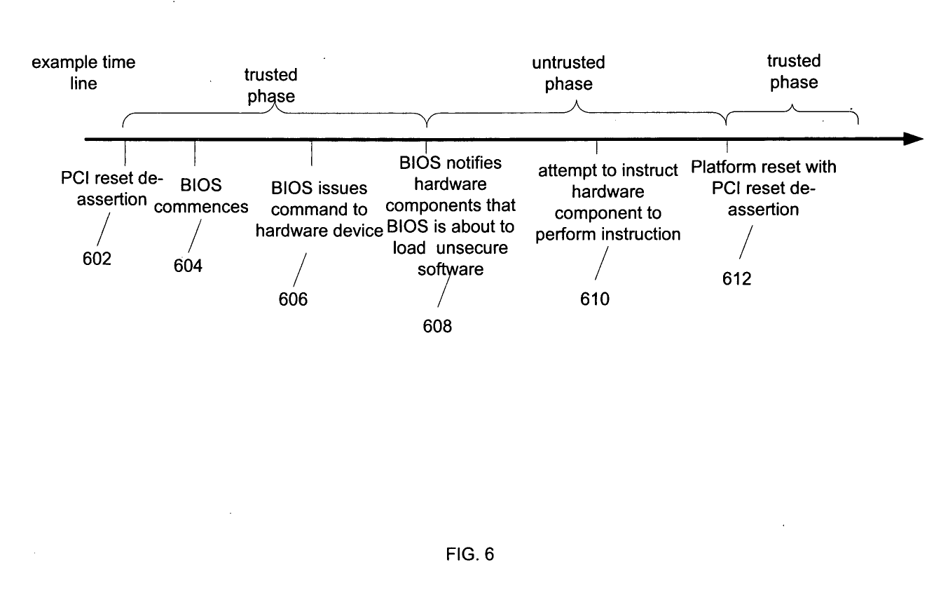

FIG. 6 depicts an example timing diagram showing movement between trusted and untrusted phases, in accordance with an embodiment of the present invention. At 602, hardware components detect a PCI reset de-assertion and enter the trusted phase.

At 604, a BIOS commences operation during the trusted phase. At 606, the BIOS issues commands to at least one hardware component. For example, the command may include the request for the hardware component to store information provided by the BIOS such as hardware asset information. Each of the at least one hardware components complies with the command.

At 608, BIOS notifies at least one hardware component that the BIOS is about to load unsecure software. After receiving the notification that the BIOS is about to load unsecure software, each hardware component enters an untrusted phase. At 610, a software routine or device attempts to instruct a hardware component in an untrusted phase to perform an instruction. Because the hardware component is in an untrusted phase, the hardware component ignores the command or otherwise issues a false response (such as a predetermined response). At 612, the platform resets and a PCI reset de-assertion is issued to the hardware components. The hardware components thereby re-enters the trusted phase.

### MODIFICATIONS

The drawings and the forgoing description gave examples of the present invention. Although depicted as a number of disparate functional items, those skilled in the art will appreciate that one or more of such elements may well be combined into single functional entities. Alternatively, certain elements may be split into multiple functional elements. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A method comprising:
responding to a first triggering signal by entering a trusted phase;
complying with commands from any external source received during the trusted phase;
responding to a second triggering event by entering an untrusted phase; and
not complying with commands from any external source received during the untrusted phase.

2. The method of claim 1, further comprising:
providing information for storage during the trusted phase.

3. The method of claim 2, wherein the information comprises host system asset information.

4. The method of claim 2, wherein the information comprises host system boot record.

5. The method of claim 2, further comprising:
receiving a request provided through a network for the stored information; and
transferring the stored information to the requester through the network.

6. The method of claim 1, wherein the first triggering signal comprises an indication that a trusted source is to be executed next.

7. The method of claim 1, wherein the second triggering signal comprises an indication prior to executing any untrusted source.

8. An apparatus comprising:
hardware component logic; and
a filter device configured to:
respond to a first triggering signal by entering a trusted phase,
transfer commands to the hardware component logic from any external source received during the trusted phase,
respond to a second triggering event by entering an untrusted phase, and
not transfer commands to the hardware component logic from any external source received during the untrusted phase.

9. The apparatus of claim 8, wherein the hardware component logic includes a memory device and wherein the filter device is to transfer information received during the trusted phase for storage in the memory device.

10. The apparatus of claim 9, wherein the information comprises asset information of a host system.

11. The apparatus of claim 9, wherein the information comprises a boot record of a host system.

12. The apparatus of claim 8, wherein the first triggering signal comprises an indication that a trusted source is to be executed next.

13. The apparatus of claim 8, wherein the second triggering signal comprises an indication prior to executing any untrusted source.

14. A system comprising:
a host system comprising a processor, a memory device, storage device, and an intercommunication platform;
a network interface communicatively coupled to the intercommunication platform, the network interface comprising:
hardware component logic; and
an I/O device configured to:
respond to a first triggering signal by entering a trusted phase,
transfer commands to the hardware component logic from any external source received during the trusted phase,
respond to a second triggering event by entering an untrusted phase, and
not transfer commands to the hardware component logic from any external source received during the untrusted phase.

15. The system of claim 14 wherein the intercommunication platform includes a PCI compatible bus.

16. The system of claim 14 wherein the intercommunication platform includes a PCI express compatible bus.

17. A system comprising:
at least one managed client device, wherein the managed client device comprises:
hardware component logic; and
an I/O device configured to:
respond to a first triggering signal by entering a trusted phase,
transfer commands to the hardware component logic from any external source received during the trusted phase,
respond to a second triggering event by entering an untrusted phase, and
not transfer commands to the hardware component logic from any external source received during the untrusted phase; and
a management console configured to communicate with the at least one managed client device using a network.

18. The system of claim 17, wherein the hardware component logic includes a memory and wherein during the trusted phase, the I/O device transfers asset information of a host system for storage into the memory.

19. The system of claim 18, wherein the information comprises asset information of a host system.

20. The system of claim 18, wherein the information comprises a boot record of a host system.
